(19) United States
(12) Patent Application Publication
(10) Pub. No.: US 2016/0063599 A1
(43) Pub. Date: Mar. 3, 2016

(54) MATCHING A PRODUCT WITH OTHER PRODUCTS

(71) Applicant: Wal-Mart Stores, Inc., Bentonville, AR (US)

(72) Inventors: Stuart Argue, Palo Alto, CA (US); Anthony Emile Marcar, San Francisco, CA (US)

(21) Appl. No.: 14/473,808

(22) Filed: Aug. 29, 2014

(51) Int. Cl. G06Q 30/06; G06F 17/30

(52) U.S. Cl. CPC G06Q 30/0631; G06F 17/30495; G06F 17/30395

(57) ABSTRACT

The present invention extends to methods, systems, and computer program products for matching a product with other products. A purchase history module can maintain a purchase history (e.g., a collection of digital receipts) for each of a merchant's customers. The purchase histories can be searched to identify (or recommend) one or more products that are compatible with another product. In one aspect, a search identifying a product is sent from a mobile device to the purchase history module. The purchase history module identifies one or more other products compatible with the product. An indication of the one or more products is returned back to the mobile device.

### CROSS-REFERENCE TO RELATED APPLICATIONS

Not applicable.

### BACKGROUND

1. Field of the Invention

This invention relates generally to the field of electronic sales transactions, and, more particularly, to matching a product to other products.

2. Related Art

In a variety of transactions, consumers or buyers of goods or services typically receive receipts from their respective merchants or service providers as proof of existence of conducted transactions. Generally, receipts are issued by merchants and service providers for a number of reasons including, for example, regulatory or tax reasons and convenience purposes. A receipt provides information about a corresponding transaction for the purpose of providing all participants with a trace or record of the transaction. Receipts can later be used by a consumer for various purposes including, for example, proving participation in a transaction for tax reporting purpose, product returns, use as a claim ticket for a further transaction, provisioning warranties, etc. Depending on a variety of factors, such as, for example, items being purchased, business or personal purchase, amount of purchase, etc., a consumer may desire an electronic receipt and/or a paper receipt.

For in-store purchases, consumers generally obtain a paper receipt at the point-of-sale. However, some point-of-sale systems also support the delivery of digital receipts at the point-of-sale or delivered electronically after the fact from a backend system. Further, for telephone or online purchases, digital receipts are typically delivered to a customer.

However, digital receipts are typically not managed in any coordinated manner. For example, a user may have a number of digital receipts in their email but may have limited, if any, mechanism to beneficially leverage the contents of the digital receipts. Similarly, a merchant may send digital receipts to many customers but may not use the data contained in the receipts for any beneficial purpose.

### BRIEF DESCRIPTION OF THE DRAWINGS

The specific features, aspects and advantages of the present invention will become better understood with regard to the following description and accompanying drawings where:

FIG. 1 illustrates an example block diagram of a computing device.

FIG. 2 illustrates an example computer architecture that facilitates matching a product to other products.

FIG. 3 illustrates a flow chart of an example method for matching a product to other products.

FIG. 4 illustrates an example schematic block diagram of a point-of-sale (“POS”) system that creates receipts for mobile devices.

FIG. 5 illustrates an example schematic block diagram of a network of point-of-sale (“POS”) systems that creates receipts for mobile devices.

### DETAILED DESCRIPTION

The present invention extends to methods, systems, and computer program products for matching products to other products. In the following description of the present invention, reference is made to the accompanying drawings, which form a part hereof, and in which is shown by way of illustration specific embodiments in which the invention is may be practiced. It is understood that other embodiments may be utilized and structural changes may be made without departing from the scope of the present invention.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. RAM can also include solid state drives (SSDs or PCIx based real time memory tiered Storage, such as FusionIO). Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the invention can also be implemented in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

It is further noted that, where feasible, functions described herein can be performed in one or more of: hardware, software, firmware, digital components, or analog components. For example, one or more application specific integrated circuits (“ASICs”) can be programmed to carry out one or more of the systems and procedures described herein. Certain terms are used throughout the following description and Claims to refer to particular system components. As one skilled in the art will appreciate, components may be referred to by different names. This document does not intend to distinguish between components that differ in name, but not function.

In general, embodiments of the invention are directed to matching a product with other products. A merchant can use a Point-Of-Sale (POS) system to conduct purchase transactions for customers. The POS system can communicate customer purchase information (e.g., digital receipts) to a purchase history module. The purchase history module can maintain a purchase history (e.g., a collection of digital receipts) for each of the merchant's customers in a purchase history database. As customers make new purchases, purchase data can be indicated to the purchase history module. Per customer, the purchase history module can track and/or group products that are purchased as part of the same transaction and/or are purchased within a specified time of one another (e.g., a wine and cheese pairing).

Subsequently, the tracked and/or grouped products can be used to assist other customers with matching a product to other compatible products. A mobile device can scan a barcode for a product. A customer module at the mobile device (e.g., a client portion of a merchant application) can formulate search criteria along with barcode data into a compatible product search. The compatible product search can be associated with an application identifier for the customer module. The application identifier is used to distinguish the customer from other customers. The mobile device can submit the compatible product search to the purchase history module.

The purchase history module can receive the compatible product search from the mobile device. The purchase history module can search the purchase history database for other products compatible with (or matching) the scanned product. The purchase history module can identify one or more compatible (or matching) products at least in part by applying product matching rules to the compatible product search. The purchase history module can return an indication of any compatible (or matching) products back to the mobile device.

The mobile device can receive an indication of any compatible (or matching) products from the purchase history module. The mobile device can display information about any compatible (or matching) products (e.g., images, item description, etc.) at a display device. Accordingly, in essentially an automated manner, a customer is provided with suggestions for other products compatible with a product they intend to purchase or are considering purchasing. For example, a particular seasoning can be returned in response to scanning a barcode on a steak.

In some aspects, a purchase history module considers customer purchase history for a customer that submitted a compatible product search when identifying compatible products. In some aspects, a purchase history module also considers aggregate customer purchase history for one or more other customers when identifying compatible products. The one or more other customers may be determined to have similar purchasing patterns to the customer.

In some aspects, a purchase history for a customer is derived from one or more digital receipts. The one or more digitals receipts can be used to determine products for the customer's past purchases. When searching for compatible products, a purchase history module can consider various characteristics of previously purchased products. For example, the purchase history module can determine if a customer tends to purchase more generic or more name brand items, if a customer tends to purchase more products from a particular supplier or manufacturer, if a customer tends to be price sensitive, if a customer tends not to be price sensitive, whether prior recommendations for compatible products were acted upon, etc.

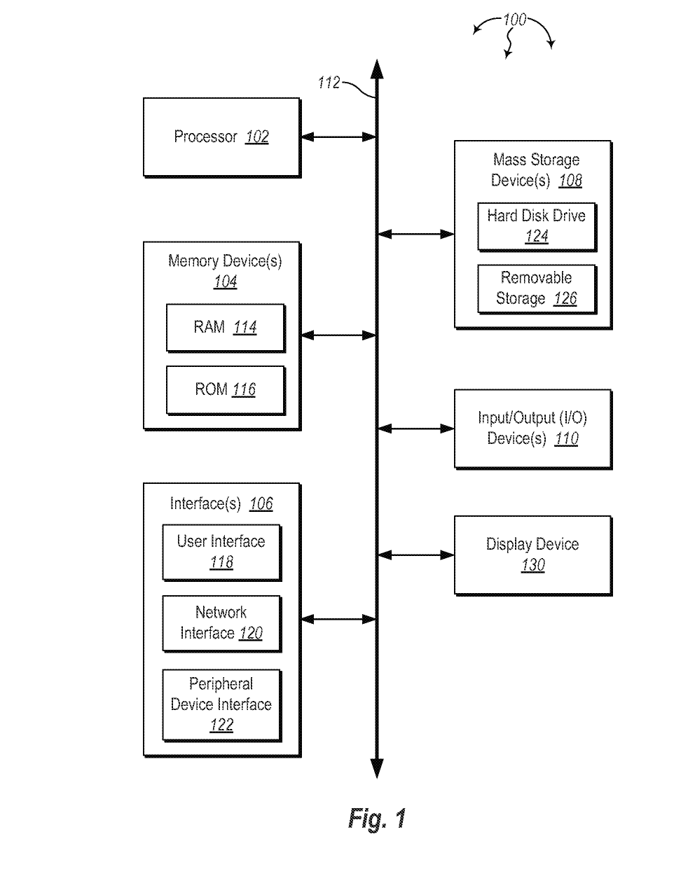

FIG. 1 illustrates an example block diagram of a computing device 100. Computing device 100 can be used to perform various procedures, such as those discussed herein. Computing device 100 can function as a server, a client, or any other computing entity. Computing device 100 can perform various communication and data transfer functions as described herein and can execute one or more application programs, such as the application programs described herein. Computing device 100 can be any of a wide variety of computing devices, such as a mobile telephone or other mobile device, a desktop computer, a notebook computer, a server computer, a handheld computer, tablet computer and the like.

Computing device 100 includes one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer-readable media, such as cache memory.

Memory device(s) 104 include various computer-readable media, such as volatile memory (e.g., random access memory (“RAM”) 114) and/or nonvolatile memory (e.g., read-only memory (“ROM”) 116). Memory device(s) 104 may also include rewritable ROM, such as Flash memory.

Mass storage device(s) 108 include various computer readable media, such as magnetic tapes, magnetic disks, optical disks, solid state memory (e.g., Flash memory), and so forth. As shown in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media.

I/O device(s) 110 include various devices that allow data and/or other information to be input to or retrieved from computing device 100. Example I/O device(s) 110 include cursor control devices, keyboards, keypads, microphones, monitors or other display devices, speakers, printers, network interface cards, modems, cameras, lenses, CCDs or other image capture devices, and the like.

Display device 130 includes any type of device capable of displaying information to one or more users of computing device 100. Examples of display device 130 include a monitor, display terminal, video projection device, and the like.

Interface(s) 106 include various interfaces that allow computing device 100 to interact with other systems, devices, or computing environments. Example interface(s) 106 can include any number of different network interfaces 120, such as interfaces to personal area networks (“PANs”), local area networks (“LANs”), wide area networks (“WANs”), wireless networks (e.g., near field communication (“NFC”), Bluetooth, Wi-Fi, etc. networks), and the Internet. Other interfaces include user interface 118 and peripheral device interface 122.

Bus 112 allows processor(s) 102, memory device(s) 104, interface(s) 106, mass storage device(s) 108, and I/O device(s) 110 to communicate with one another, as well as other devices or components coupled to bus 112. Bus 112 represents one or more of several types of bus structures, such as a system bus, PCI bus, IEEE 1394 bus, USB bus, and so forth.

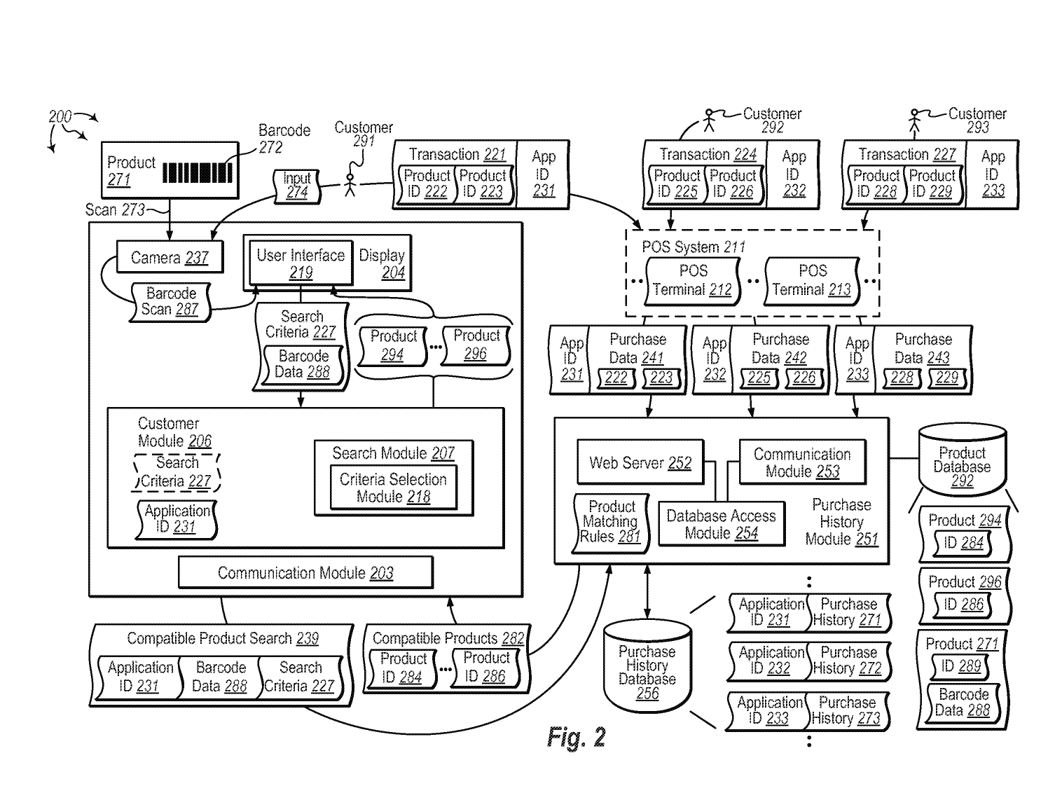

FIG. 2 illustrates an example computer architecture 200 that facilitates matching a product to other products. Referring to FIG. 2, computer architecture 200 includes mobile device 201, Point-Of-Sale (POS) system 211, and purchase history module 251. Each of the depicted components can be connected to one another over (or be part of) a network, such as, for example, a PAN, a LAN, a WAN, and even the Internet. Accordingly, each of the depicted components as well as any other connected computer systems and their components, can create message related data and exchange message related data (e.g., near field communication (“NFC”) payloads, Bluetooth packets, Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

POS system 211 includes a plurality of POS terminals including POS terminals 212, 213, etc. POS terminals in POS system 211 can be located in a variety of different geographic locations. Some POS terminals can be in the same store location. Other POS terminals can be in different store locations. The POS terminals can be distributed across different cities, states and countries.

In general, a POS terminal can include a transaction processor, a communication module, and I/O peripherals. Generally, a transaction processor is configured to manage sales transactions for a POS terminal. A transaction processor can receive input from I/O peripherals to open a sales transaction, collect receipt data (e.g., date, time, item, number of units, cost data, tax, department, payment method, etc.) for a sales transaction, and close a sales transaction. Item data for an item (e.g. item description, item cost, department, etc.) can be retrieved from an item database in response to scanning a barcode on (or otherwise identifying) the item. For example, a barcode scanner in I/O peripherals can be used to a product barcode. From the scan, a POS terminal can derive barcode data used to obtain other item data. Barcode data obtained from scanning an item barcode can be linked to other item data within an item database. Barcode data can also be retained within item data for inclusion in a digital receipt.

Further item data for an item (e.g., number of units, tax, payment method, etc.) can be determined by the transaction processor. Item data for one or more items can be combined with other data (e.g., coupons, surveys, etc.) to form digital receipt data for a transaction.

I/O peripherals can include one or more of: a monitor (e.g., a cashier-facing monitor), one or more input devices (e.g., barcode scanners, keyboards, scales, or the like), one or more payment devices (e.g., cash drawers, card readers, etc.) for receiving or returning payments, and one or more output devices (e.g., customer-facing display or monitor, receipt printer, etc.).

A POS terminal can associate an application ID with purchase data (e.g., with digital receipt data) for a transaction. The application ID can be a unique value identifying a mobile device. An application ID can be indicated to a POS system terminal, either manually by a customer or in an automated fashion by a mobile device, at the time of a transaction. For example, application ID 231 can be associated with transactions for customer 291. Application ID 232 can be associated with transactions for customer 292. Application ID can be associated with transactions for customer 293.

A communication module can be a wired and/or wireless network adapter for connecting a POS terminal with a network, such as, for example, a Wi-Fi and/or wired Ethernet network, that facilitates a further connection to a network (e.g., the Internet).

A POS terminal can be at a physical store location along with additional POS terminals including similar components. The physical store location may be owned by an entity, such as, for example, a retailer corporation that runs a chain of stores. The chain of stores can include one or more of: grocery stores, department stores, warehouse stores, discount stores, etc. In some aspects, POS system 211 includes components in a checkout isle as well as components in a store based data center. Other POS systems, also including similar components, can be at other physical store locations owned by the entity.

Purchase history module 251 includes network (e.g., web) server 252, communication module 253, and database access module 254. Network server 252 is configured to communicate with external devices, such as, mobile device 201. A common entity, such as, a retailer corporation, can own one or more physical store locations (e.g., a chain of stores) as well as purchase history module 251. Each of the one or more store physical locations can include one or more POS terminals as well as other computer systems (e.g., local backend servers). Communication module 253 can be configured to communicate with POS terminals as well as other computer systems at each of the one or more physical store locations (e.g., on an internal corporate network) to facilitate business operations for the entity.

As transactions are completed, purchase history module 251 can receive application identifiers and indications of purchased products from POS terminals at various different store locations, including POS terminals 212 and 213. Purchase history module 251 can formulate purchase histories from received purchases products. Formulated purchase histories can include item data for items included in corresponding digital receipt data (but potentially in a different format, for example, a format deliverable to mobile devices). Formulated purchase histories can also contain other data related to a transaction, such as, for example, the payment method used for the transaction, coupons, surveys, etc. Database access module 254 can store purchase histories along with application identifiers in receipt database 256.

For example, customer 291 can participate in transaction 221 with POS system 211 to purchase products identified by product IDs 222, 223, etc. Upon completion of transaction 221, POS system 211 can forward application ID 231 along with purchase data 241 to purchase history module 251. Purchase history module 254 can update purchase history 271 to include product IDs 222, 223, etc. Application ID 231 is used to indicate that purchase history 271 corresponds to mobile device 201.

Similarly, customer 292 can participate in transaction 224 with POS system 211 to purchase products identified by product IDs 225, 226, etc. Upon completion of transaction 224, POS system 211 can forward application ID 232 along with purchase data 242 to purchase history module 251. Purchase history module 254 can update purchase history 272 to include product IDs 225, 226, etc. Application ID 232 is used to indicate that purchase history 272 corresponds to a mobile device associated with customer 292.

Likewise, customer 293 can participate in transaction 227 with POS system 211 to purchase products identified by product IDs 228, 229, etc. Upon completion of transaction 227, POS system 211 can forward application ID 233 along with purchase data 243 to purchase history module 251. Purchase history module 254 can update purchase history 273 to include product IDs 228, 229, etc. Application ID 233 is used to indicate that purchase history 273 corresponds to a mobile device associated with customer 293.

When appropriate, purchase history module 251 can refer to product database 292 to match product IDs to other product information, such as, for example, images, descriptions, price, bar code data, etc., for a product.

Thus, as customers purchase products from a merchant, a corpus of customer purchase histories is maintained and updated for the merchant. The corpus of customer purchase histories can be searched to identify and/or recommend products that may be compatible with other products. A compatible product may be a product that another customer purchased along with a product that is the subject of a compatible product search.

In some aspects, purchase history module 251 is part of a (e.g., regional, national, or global) backend system that receives purchase data from a plurality of POS terminals distributed throughout different geographic locations and formulates corresponding purchase histories. The plurality of POS terminals and the backend system can be part of a commonly owned and/or controlled corporate network infrastructure. For example, purchase history module 251 can formulate purchases histories 272 and 273 from purchase data received from other POS terminals. Purchase data can indicate purchased products. For example, purchase data 241 indicates that products 222, 223, etc. were purchased.

In addition to formulating and/or amending purchase histories, purchase history module 251 can find and/or recommend products compatible with one another. Purchase history module 251 can send identified and/or recommended compatible products to customer mobile devices. For example, in response to a compatible product search for a product, purchase history module 251 can send an indication of (e.g., a list of or recommendations for) compatible products to a smartphone or tablet. Sending an indication of compatible products from purchase history module 251 to a mobile device can involve push or polled mechanisms. Purchase history module 251 can send an indication of compatible products in a web or native view.

As depicted, mobile device 201 (e.g., a smartphone) includes communication module 203, display 204, customer module 206, and camera 237. In general, customer module 206 provides a user of mobile device 201 with various mechanisms for finding one or more products that may be compatible or recommended for purchase with another product. Customer module 206 further includes search module 207. Search module 207 is configured to formulate a compatible product search to customer specifications. Customer module 206 can be also be used to pair customer application ID 231 (e.g., derived from a loyalty number, a telephone number, a portion of a credit card number, etc.) with mobile device 201. As such, responses to requests corresponding to application ID 231 can be delivered to mobile device 201.

Customer module 206 can present user-interface 219 at display 204 (e.g., a general purpose display device). User-interface 219 can include (e.g., touch screen) user-interface controls allowing a user to select search criteria. Selected search criteria can be used by search module 207 to formulate a compatible product search. For example, customer 291 can send input 274 to cause camera 237 to scan 273 barcode 272 on product 271. Scan 273 can result in camera 237 capturing barcode scan 287. From scan 273, mobile device 201 can derive barcode data 288. Barcode data 288 can be included in search criteria 227 to configure a compatible product search for customer 291. Search module 207 can use search criteria 227 for formulate a compatible product search for products compatible with product 271. For example, customer 291 may be interested in cheese recommendations for a particular wine.

Search criteria 227 can be varied to adjust scope for searching for identified compatible products. For example, search criteria 227 can be varied to search for compatible products previously purchased by customer 291, to search for compatible products previously purchased by other customers with purchasing habits similar to customer 291, to search for compatible products previously purchased within a designated time range (e.g., last week, last month, etc.), to search for compatible products from specified manufacturers, etc.

In some aspects, search module 207 can also include functionality for normalizing barcode data 288. For example, search module 207 can add, remove, and/or check digits, pad with zeros, etc. Search module 207 can also perform transformations on price embedded barcodes to show search on purchase price.

Thus, a user request for compatible products can be accomplished by selecting search criteria through user interface 291. The search criteria are sent to search module 207. Search module 207 applies the search criteria to formulate a compatible product search.

As depicted, search module 207 includes criteria selection module 218. Criteria selection module 218 can present user interface controls to facilitate search criteria selection by a user. Criteria selection module 218 can present any of a wide variety of different user interface controls in different combinations, including, but not limited to: check boxes, radio buttons, lists, drop down lists, combo boxes, text boxes, date pickers, option buttons, sliders, etc. Criteria selection module 218 can receive search criteria selected through the presented user interface controls. In some aspects, criteria selection module 218 includes specific user interface controls for obtaining a bar code scan.

In some aspects, web server 252 includes a search module. The search module can include a criteria selection module (similar to criteria selection module 218). The search module can be a standalone module or can interoperate with search module 207 (e.g., in a hybrid manner) to search for compatible products. The search module can include a web based user interface. A user, for example, customer 291 can interact with search module through the web based user interface. The search module can provide a mobile web view of search results back to mobile device 201.

For example, customer 291 can select search criteria, including barcode data, through a Web based interface provided by the search module. The search criteria can be sent to the search module via network communication. The search module can search for compatible products in purchase history database 256. Identified compatible products can be returned to mobile device 201 via network communication for presentation in a mobile web view.

Search criteria may be stored between searches. For example, customer 291 can select search criteria 227. Search criteria 227 can be persisted in customer module 206. Search criteria 227 can be used to search for compatible products to display at user interface 219, for example, when custom module 206 is started up or when other search criteria have not been selected.

In response to a compatible product request, database access module 254 can use an application ID to identify compatible products from a customer's purchase history. Database access module 254 can also use various machine intelligence techniques to identify compatible products from the purchase histories of other users. In some aspects, database access module 254 refers to product matching rules 281 when searching for compatible products. Product matching rules 281 can define various searching parameters. For example, product matching rules 281 can define a requisite similarity between purchasing habits of different customers to consider the different customers as having similar purchasing habits. Customers with similar purchasing habits can be grouped together when searching for compatible products.

Communication module 203 can be a wireless network adapter for connecting mobile device 201 with a wireless network, such as, for example, Wi-Fi and/or a cellular network (e.g., CDMA, GSM, iDen, etc.) that facilitates a further connection to other networks (e.g., the Internet)

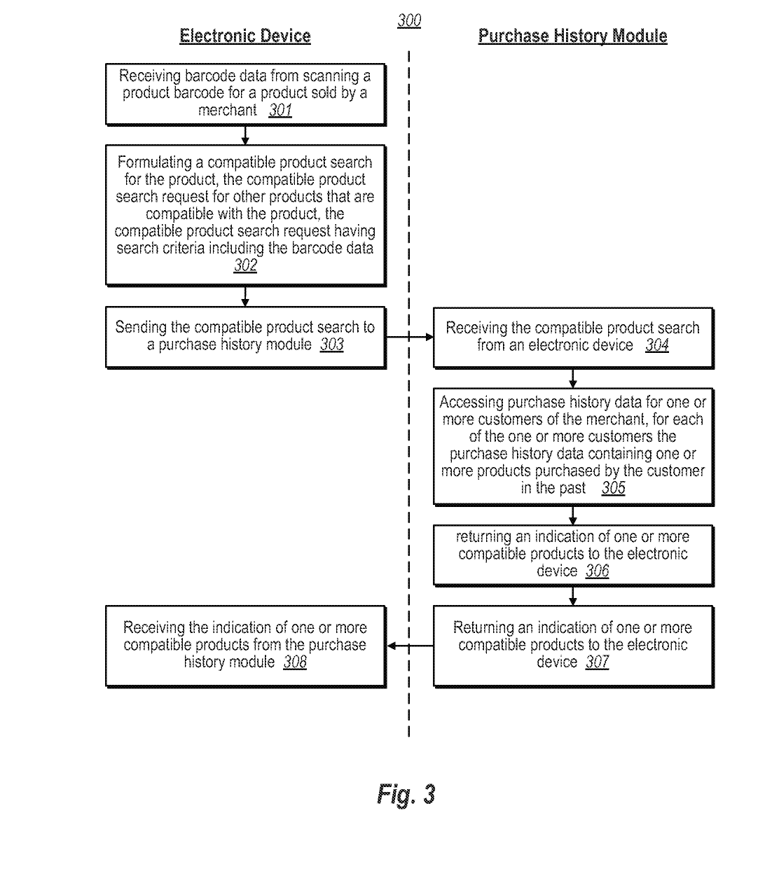

FIG. 3 illustrates a flow chart of an example method 300 for matching a product to other products. Method 300 will be described with respect to the components and data in computer architecture 200.

Method 300 includes receiving barcode data from scanning a product barcode for a product sold by a merchant (301). For example, customer 291 can enter input 274 into mobile device 201 to cause camera 230 to scan 273 barcode 272 on product 271. Customer 291 can be in a merchant retail location when barcode 272 is scanned. In response, barcode scan 287 can be send to user interface 219. Criteria selection module 218 can present user interface controls at user interface 219 for selecting search criteria. Customer 291 can enter further input to select search criteria 227 including barcode data 288. Search module 207 can receive search criteria 227, including barcode data 288.

Method 300 includes formulating a compatible product search request for the product, the compatible product search request for other products that are compatible with the product, the compatible product search request having search criteria including the barcode data (302). For example, search module 207 can formulate compatible product search 239 for product 271. Compatible product search 239 includes application ID 231, barcode data 288, and search criteria 227. Compatible product search 239 can be a search for other products that are compatible with product 271.

Method 300 includes sending the compatible product search to a purchase history module (303). For example, mobile device 201 can send compatible product search request 239 to purchase history module 251. Method 300 includes receiving the compatible product search from an electronic device (304). For example, purchase history module 251 can receive compatible product search request 239 from mobile device 201. Purchase history module 251 can refer to product database 292 to match bar code data 288 to product ID 289 for product 271.

Method 300 includes accessing purchase history data for one or more customers of the merchant, for each of the one or more customers the purchase data containing one or more products purchased by the customer in the past (305). For example, database access module 254 can access one or more of purchase history histories 271, 272, 273, etc. In one aspect, search criteria 227 can define that customer 291 is interested in compatible products from their own prior purchases. As such, database access module 254 can access purchase history 271. In another aspect, search criteria 227 can define that customer 291 is interested in compatible products from other customer's prior purchases. In these other aspects, search criteria 227 can define an interest in compatible products for all other customers or a specified subset of other customers (e.g., customers with similar purchasing habits). As such, database access module 254 can access one or more other purchase histories, including purchase history 272, 273, etc. In a further aspect, search criteria 227 can define that customer 291 is interested in compatible products from their own prior purchases and also interested in compatible products from other customer's prior purchases. As such, database access module 254 can access purchase history 271 as well as one or more of purchase histories 272, 273, etc.

As appropriate, database access module 254 can refer to product matching rules 281 to determine if a purchase history for a customer is to be accessed. For example, database access module 254 can determine if customer 291 has purchase habits similar to another customer by referring to product matching rules 281. If purchasing habits are similar (e.g., both often buy generic or value brands), database access module 254 can access the purchase history for the other customer.

Method 300 includes identifying one or more compatible products contained in the purchase history data as compatible with the product by applying one or more matching rules in accordance with the search criteria to the purchase data (306). For example, database access module 251 can identify products 294 and 296 as compatible with product 271. In some aspect, database access module 251 determines how often the product ID for product

Products 294 and 296 can be identified from a product database for the merchant. Database access module 254 can identify products 294 and 296 from purchase history 271 and/or one or more of purchase histories 272, 273, etc. Database access module 254 can apply product matching rules 281 in accordance with search criteria 227 to identify products 294 and 296. For example, search criteria 227 can indicate that compatible products are to be identified from other customers with similar purchase habits. Database access module 254 can then refer to product matching rules 281 to determine a requisite similarity between purchase histories for one customer to have similar purchase habits to another customer. Purchase histories for customers with similar purchase habits can be search for compatible products.

Matching rules 281 can also define when a product is compatible with another product. A product may be identified as compatible with another product at least in part when combined purchases of the product and the other product exceed a specified threshold. For example, if a razor is frequently purchased with a shaving cream, the shaving cream can be identified as a compatible product for the razor. A product may be identified as compatible with another product due at least in part to the other product being part of a promotion (e.g., a sale). A product may be identified as compatible with another product due at least in part to characteristics of the other product, such as, for example, price, manufacturer, brand, etc.

Method 300 includes returning an indication of one or more compatible products to the electronic device (307). For example, purchase history module 251 can return compatible products 282, including product identifiers 284 and 286 (for products 294 and 296 respectively), to mobile device 201. Method 300 includes receiving the indication of one or more compatible products from the purchase history module (308). For example, mobile device 201 can receive compatible products 282, including product identifiers 284 and 286, from purchase history module 251. Customer module 206 can refer to product database 292 (and may have portions of product database 292 stored locally) to determine that product identifiers 284 and 286 correspond to products 294 and 296. Customer module 207 can display information about products 294 and 296, such as, for example, images and descriptions, at user interface 219.

In some aspects, a purchase history for a customer includes a collection of digital receipts for the customer. A receipt data server collects digital receipts as customer transactions are completed. Application IDs can be used to associate a mobile device (and thus a customer) with a corresponding collection of digital receipts. A module at the receipt data server can search through digital receipts to identify one or more products that may be compatible with another product. The module at the receipt data server can refer to a product database and/or to product matching rules to assist with identifying compatible products.

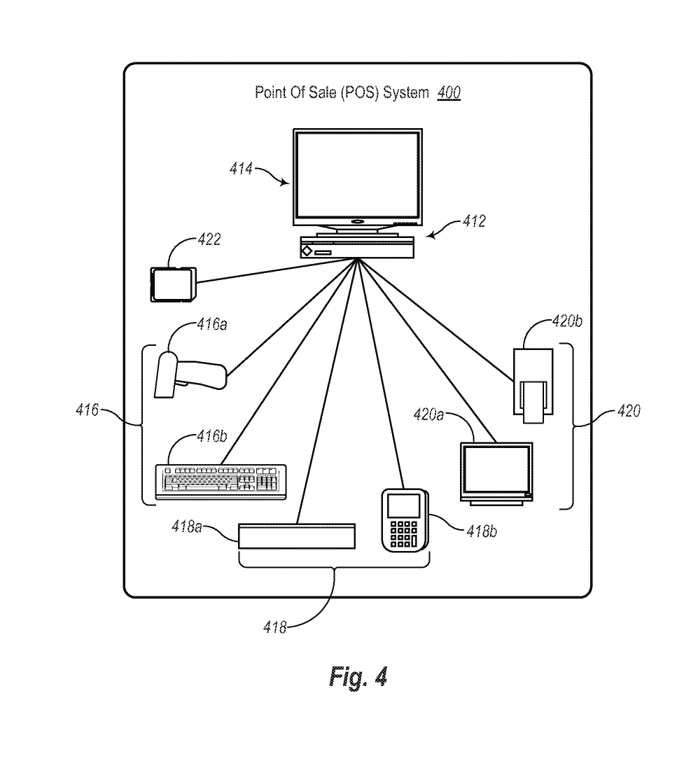

FIG. 4 illustrates an example schematic block diagram of a point-of-sale (POS) system 400. In some embodiments, the hardware, software, or hardware and software of POS system 400 may be configured to implement one or more methods in accordance with the present invention. For example, POS system 400 may be manufactured, programmed, modified, or upgraded to support transferring digital receipt data to a receipt data server. POS systems 211 can be a POS system similar to POS system 400.

POS system 400 can include various components. In some embodiments, POS system 400 includes a central or primary computer 412, a monitor 414 (e.g., a cashier-facing monitor 414), one or more input devices 416 (e.g., scanners 416a, keyboards 416b, scales, or the like), one or more payment devices 418 (e.g., cash drawers 418a, card readers 418b) for receiving or returning payments, one or more output devices 420 (e.g., customer-facing display 420a or monitor 420a, receipt printer 420b), or the like or combinations or sub-combinations thereof, and NFC module 422, such as, for example, an NFC dongle.

Computer 412 may form the backbone of POS system 400. Other components 416, 418, 420, 422 forming part of a POS system 400 can communicate with computer 412. Input devices 416 and certain payment devices 418 can feed data and commands to computer 412 for processing or implementation. For example, (barcode) scanner 416a can pass data communicating the identity of one or more items to be purchased, returned, or the like to a computer 412. Similarly, card reader 418b can pass payment information to computer 412.

On the other hand, output devices 420 and certain payment devices 418 can follow or implement commands issued by computer 412. For example, cash drawer 418a may open in accordance with the commands of computer 412. Similarly, customer-facing display 420a and receipt printer 420b can display or output data or information as instructed by computer 412.

In some embodiments, in addition to handling consumer transactions (e.g., purchases, returns), POS system 400 can provide or support certain “back office” functionality. For example, POS system 400 can provide or support inventory control, purchasing, receiving and transferring products, or the like. POS system 400 can also store sales and customer information for reporting purposes, marketing purposes, receivables management, trend analysis, cost analysis, price analysis, profit analysis, or the like. If desired or necessary, POS system 400 can include an accounting interface to pass certain information to one or more in-house or independent accounting applications.

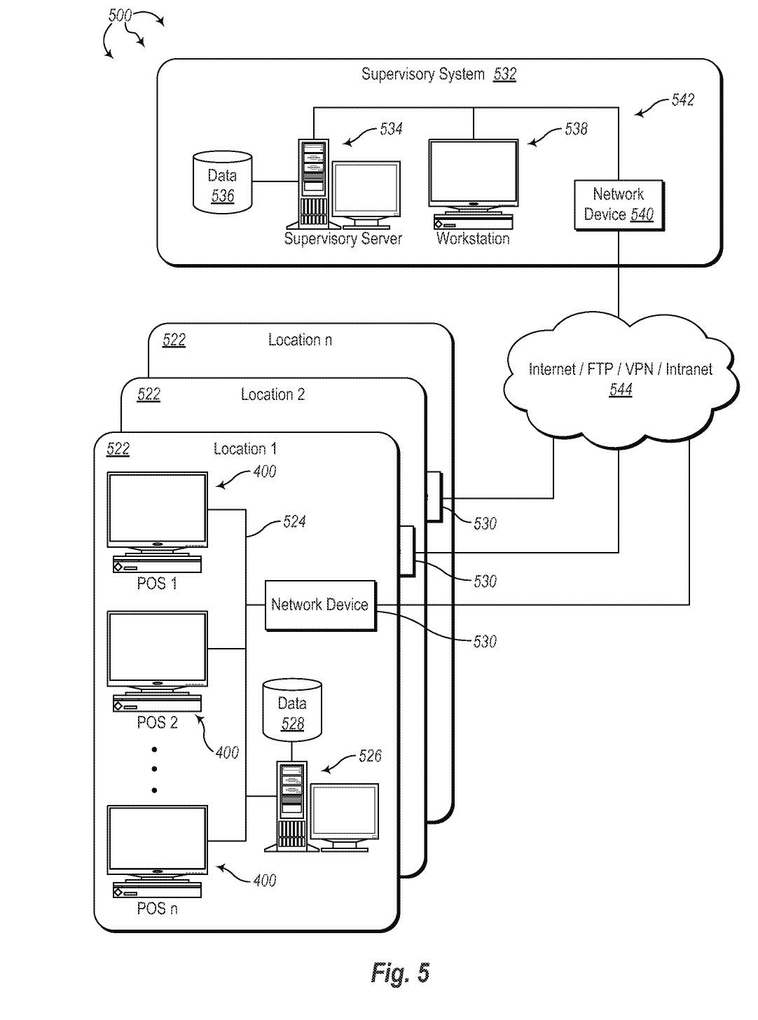

In some embodiments, POS system 400 operates substantially independently, as a stand-alone unit. Alternately, POS system 400 may be one of several POS systems 400 forming the front line of a larger system. FIG. 5 illustrates an example schematic block diagram of a network 500 of point-of-sale (POS) systems 400. For example, multiple POS systems 400 may operate at a particular location 522 (e.g., within a retail, brick-and-mortar store). In such embodiments, the various POS systems 400 may be interconnected via LAN 524. LAN 524 may also connect the POS systems 500 to a local server 526.

Local server 526 can support the operation of the associated POS systems 400. For example, a server 526 may provide a central repository from which certain data needed by the associated POS systems 400 may be stored, indexed, accessed, or the like. Server 526 can serve certain software to one or more POS systems 400. In certain embodiments, a POS system 400 can offload certain tasks, computations, verifications, or the like to server 526.

Alternatively, or in addition thereto, server 526 can support certain back office functionality. For example, server 526 can receive and compile (e.g., within an associated database 528) data from the various associated POS systems 400 to provide or support inventory control, purchasing, receiving and transferring products, or the like. Server 526 can also receive and compile sales and customer information for reporting purposes, marketing purposes, receivables management, trend analysis, cost analysis, price analysis, profit analysis, or the like.

In some embodiments, one or more POS systems 400 and/or servers 526 corresponding to a particular location 522 can communicate with or access one or more remote computers or resources via one or more network devices 530. For example, a network device 530 can enable a POS system 400 to contact outside resources and verify the payment credentials (e.g., credit card information) provided by a customer. A network device 530 can comprise a modem, router, or the like.

In selected embodiments, POS systems 400 operate within an enterprise-wide system 531 comprising multiple locations 522 (e.g., branches 522 or stores 522). In such embodiments, each location 522 may have one or more POS systems 400, local servers 526, local databases 528, network devices 530, or the like or combinations or sub-combinations thereof connected by a computer network (e.g., a LAN 524). It may be that purchase history module 251 or a receipt data server are included in and/or include the functionality of a local server 526.

Additionally, each such location 522 may be configured to interact with one or more supervisory systems 532. For example, multiple branch locations 522 may report to an associated “headquarters” location or system. It may be that purchase history module 251 or a receipt data server are included in and/or include the functionality of a supervisory system 532.

A supervisory system 532 can include one or more supervisory servers 734, databases 536, workstations 538, network devices 540, or the like or combinations or sub-combinations thereof. The various components of a supervisory system 532 can be interconnected via a computer network (e.g., a LAN 542). In selected embodiments, a supervisory system 532 includes one or more supervisory servers 534 providing a central repository from which certain data needed by the one or more POS systems 400 or local servers 526 may be stored, indexed, accessed, or the like.

Alternatively, or in addition thereto, a supervisory server 534 can receive and compile (e.g., within an associated database 536) data from the various associated POS systems 400 or local servers 526 to provide or support inventory control, purchasing, receiving and transferring products, or the like. A supervisory server 534 may also receive and compile sales and customer information for reporting purposes, marketing purposes, receivables management, trend analysis, cost analysis, price analysis, profit analysis, or the like.

A supervisory system 532 can be connected to one or more associated locations 522 or branches 522 in via any suitable computer network 544 (e.g., WAN 544). For example, in selected embodiments, one or more locations 522 can connect to a supervisor system 532 via the Internet. Communication over such a network 544 can follow any suitable protocol or security scheme. For example, communication may utilize the File Transfer Protocol (FTP), a virtual private network (VPN), intranet, or the like.

Although the components and modules illustrated herein are shown and described in a particular arrangement, the arrangement of components and modules may be altered to process data in a different manner. In other embodiments, one or more additional components or modules may be added to the described systems, and one or more components or modules may be removed from the described systems. Alternate embodiments may combine two or more of the described components or modules into a single component or module.

The foregoing description has been presented for the purposes of illustration and description. It is not intended to be exhaustive or to limit the invention to the precise form disclosed. Many modifications and variations are possible in light of the above teaching. Further, it should be noted that any or all of the aforementioned alternate embodiments may be used in any combination desired to form additional hybrid embodiments of the invention.

Further, although specific embodiments of the invention have been described and illustrated, the invention is not to be limited to the specific forms or arrangements of parts so described and illustrated. The scope of the invention is to be defined by the claims appended hereto, any future claims submitted here and in different applications, and their equivalents.

What is claimed:

1. At a computer system, the computer system having a processor and system memory, a method for matching a product to one or more other products, the method comprising:
receiving a compatible product search request from an electronic device, the compatible product search request for other products that are compatible with the product sold by a merchant, the compatible product search request having search criteria including barcode data for the product;
accessing purchase data for one or more customers of the merchant, for each of the one or more customers the purchase data containing one or more products purchased by the customer in the past;
applying one or more matching rules in accordance with the search criteria to identify one or more compatible products contained in the purchase data as compatible with the product; and
returning an indication of one or more compatible products to the electronic device.

2. The method of claim 1, wherein receiving a compatible product search request from an electronic device comprises receiving a compatible product search for a customer of the merchant.

3. The method of claim 2, wherein accessing purchase data for one or more customers of the merchant comprises accessing purchase data for the customer.

4. The method of claim 3, wherein accessing purchase data for the customer comprises using an application identifier for the mobile device to locate purchase data for the customer.

5. The method of claim 2, wherein accessing purchase data for one or more customers of the merchant comprises accessing purchase data for another customer that has purchasing habits similar to the customer.

6. The method of claim 2, wherein accessing purchase data for one or more customers of the merchant comprises accessing purchase data for the customer and for one or more other customers of the merchant.

7. The method of claim 1, wherein accessing purchase data for one or more customers of the merchant comprises accessing one or more digital receipts generated from transactions involving the one or more customers.

8. The method claim 1, wherein returning an indication of one or more compatible products to the electronic device comprises returning product identifiers for each of the one or more compatible products to the electronic device.

9. At an electronic device, the electronic device having a processor and system memory, a method for matching a product to one or more other products, the method comprising:
receiving barcode data from scanning a product barcode for a product sold by a merchant;
formulating a compatible product search for the product, the compatible product search request for other products that are compatible with the product, the compatible product search request having search criteria including the barcode data;
sending the compatible product search to a purchase history module; and
receiving an indication of one or more compatible products from the purchase history module, the one or more indicated compatible products identified as compatible with the product, the one or more compatible products identified by applying matching rules in accordance with the search criteria to purchase data of one or more customers of the merchant, for each of the one or more customers the purchase data containing one or more products purchased by the customer in the past.

10. The method of claim 9, wherein formulating a compatible product search for the product comprises formulating a compatible product search for searching a purchase history of a customer associated with the electronic device.

11. The method of claim 9, wherein formulating a compatible product search for the product comprises formulating a compatible product search for searching purchase histories of one or more customers of the merchant.

12. The method as recited in claim 9, wherein sending the compatible product search to a purchase history module comprises sending an application identifier for the electronic device to the purchase history module.

13. The method of claim 9, wherein receiving an indication of one or more compatible products from the purchase history module comprises receiving product identifiers for each of the one or more compatible products.

14. A computer program product for use at a computer system, the compute program product for implementing a method for matching a product to one or more other products, the computer program product comprising one or more storage devices having stored thereon computer-executable instructions that, when executed at a processor, cause the computer system to perform the method, including the following:
receive a compatible product search request from an electronic device, the compatible product search request for other products that are compatible with the product sold by a merchant, the compatible product search request having search criteria including barcode data for the product;
access purchase data for one or more customers of the merchant, for each of the one or more customers the purchase data containing one or more products purchased by the customer in the past;
apply one or more matching rules in accordance with the search criteria to identify one or more compatible products contained in the purchase data as compatible with the product; and
return an indication of one or more compatible products to the electronic device.

15. The computer program product of claim 14, wherein computer-executable instructions that, when executed, cause the computer system to receive a compatible product search request from an electronic device comprise computer-executable instructions that, when executed, cause the computer system to receive a compatible product search for a customer of the merchant.

16. The computer program product of claim 15, wherein computer-executable instructions that, when executed, cause the computer system to access purchase data for one or more customers of the merchant comprise computer-executable instructions that, when executed, cause the computer system to access purchase data for the customer.

17. The computer program product of claim 15, wherein computer-executable instructions that, when executed, cause the computer system to access purchase data for one or more customers of the merchant comprise computer-executable instructions that, when executed, cause the computer system to access purchase data for another customer that has purchasing habits similar to the customer.

18. The computer program product of claim 15, wherein computer-executable instructions that, when executed, cause the computer system to access purchase data for one or more customers of the merchant comprise computer-executable instructions that, when executed, cause the computer system to access purchase data for the customer and for one or more other customers of the merchant.

19. The computer program product of claim 14, wherein computer-executable instructions that, when executed, cause the computer system to access purchase data for one or more customers of the merchant comprise computer-executable instructions that, when executed, cause the computer system to access one or more digital receipts generated from transactions involving the one or more customers.

20. The computer program product of claim 14, wherein computer-executable instructions that, when executed, cause the computer system to return an indication of one or more compatible products to the electronic device comprise computer-executable instructions that, when executed, cause the computer system to return product identifiers for each of the one or more compatible products to the electronic device.
